(19) United States
(12) Patent Application Publication
(10) Pub. No.: US 2026/0064794 A1
(43) Pub. Date: Mar. 5, 2026

(54) PROMPTING A LARGE LANGUAGE MODEL TO PROVIDE RECOMMENDATIONS FOR IMPROVING A WEBSITE

(71) Applicant: Maplebear Inc., San Francisco, CA (US)

(72) Inventors: Brent Scheibelhut, Toronto (CA); Bryan Pham, London (CA); Shaun Navin Maharaj, Vaughan (CA); Akshay Bagai, Toronto (CA)

(21) Appl. No.: 18/821,752

(22) Filed: Aug. 30, 2024

(51) Int. Cl. G06F 16/958; G06Q 30/0601

(52) U.S. Cl. CPC G06F 16/958; G06Q 30/0641

(57) ABSTRACT

An online system that maintains a website, such as a white-labeled website, designed by an entity retrieves a set of contextual data associated with the website, in which the set of contextual data includes information describing the entity, one or more elements of the website, or a historical performance of the website. The online system generates a prompt including the set of contextual data and a request for a set of recommendations for improving a performance of the website by updating a set of elements of the website. The online system provides the prompt to a large language model to obtain an output and extracts, from the output, the set of recommendations for improving the performance of the website. The online system sends the set of recommendations to a computing system associated with the entity.

### BACKGROUND

Online systems may maintain websites, such as white-labeled websites, designed by entities by hosting the white-labeled websites, providing website administration and security for the white-labeled websites, fulfilling orders placed via the white-labeled websites, etc. For example, an online system may allow entities to design white-labeled websites corresponding to homepages for the entities or storefronts operated by the entities. In this example, users of the online system may access the white-labeled websites to interact with content presented on the websites (e.g., by placing orders that the online system may fulfill).

However, entities that design white-labeled websites may not be aware of issues that may make the websites less user friendly, less sophisticated, etc. than they otherwise could be. For example, suppose that a white-labeled website includes an image overlaid with text, but the text does not meet accessibility guidelines or standards (e.g., the text is small or of a color that does not provide sufficient contrast with the image to be easily read). In this example, if an entity that designed the website is not familiar with the accessibility guidelines/standards, the entity also may not be aware that some or all users may have difficulty accessing the information in the text. Additionally, in this example, if the font of the text differs from that in other areas of the white-labeled website, the inconsistency may make the website appear amateurish or unsophisticated. As such, if entities that design white-labeled websites are unaware of such issues, the performance of the websites may be negatively affected.

### SUMMARY

In accordance with one or more aspects of the disclosure, an online system prompts a large language model to provide recommendations for improving a performance of a website, such as a white-labeled website. More specifically, an online system that maintains a white-labeled website designed by an entity retrieves a set of contextual data associated with the white-labeled website, in which the set of contextual data includes information describing the entity, one or more elements of the white-labeled website, or a historical performance of the white-labeled website. The online system generates a prompt including the set of contextual data associated with the white-labeled website and a request for a set of recommendations for improving a performance of the white-labeled website by updating a set of elements of the white-labeled website. The online system then provides the prompt to a large language model to obtain an output and extracts, from the output of the large language model, the set of recommendations for improving the performance of the white-labeled website. The online system sends the set of recommendations to a computing system associated with the entity.

In one or more embodiments, responsive to extracting the set of recommendations for improving the performance of the white-labeled website from the output of the large language model, the online system updates the white-labeled website based at least in part on the set of recommendations. Additionally, in one or more embodiments, the online system fine-tunes the large language model based at least in part on the set of contextual data associated with the white-labeled website. In embodiments in which the online system fine-tunes the large language model based at least in part on the set of contextual data associated with the white-labeled website, the prompt may not include the set of contextual data.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 is a flowchart of a method for prompting a large language model to provide recommendations for improving a performance of a white-labeled website, in accordance with one or more embodiments.

FIGS. 4A-4C illustrate an example of a recommendation for updating a layout of a white-labeled website, in accordance with one or more embodiments.

FIGS. 5A-5B illustrate an example of a recommendation for updating an image included in a white-labeled website, in accordance with one or more embodiments.

FIGS. 6A-6B illustrate an example of a recommendation for updating text included in a white-labeled website, in accordance with one or more embodiments.

FIGS. 7A-7B illustrate an example of a recommendation for updating a collection of items included in a white-labeled website, in accordance with one or more embodiments.

### DETAILED DESCRIPTION

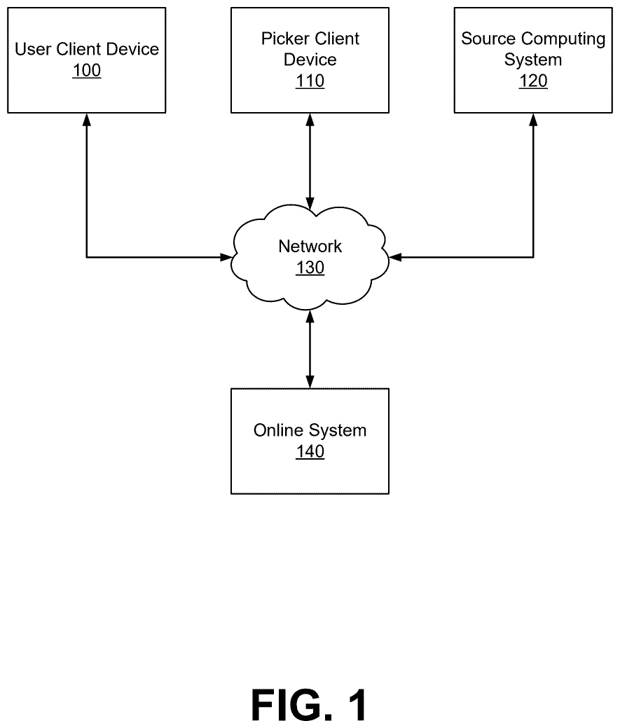

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 may be a personal or mobile computing device, such as a smartphone, a tablet, a laptop computer, or a desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, refers to a good or a product that may be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user may use to place an order with the online system 140. The ordering interface may be part of a client application operating on the user client device 100. The ordering interface allows the user to search for items that are available through the online system 140 and the user may select which items to add to an “ordering list.” An “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the items should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 may be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source location. The picker client device 110 presents the items that are included in the user's order to the picker in a collection interface. The collection interface is a user interface that provides information to the picker identifying items to collect for a user's order and indicating the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source location, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker may use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may identify the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 provides instructions to a picker for delivering the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they may use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system 140 and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user collecting items for themselves within the source location. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, a warehouse, or any other source location from which a picker may collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Furthermore, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The user client device 100, the picker client device 110, the source computing system 120, and the online system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

As an example, the online system 140 may allow a user to order groceries from a grocery store source. The user's order may specify which groceries they want to be delivered from the grocery store source and the quantities of each of the groceries. The user's client device 100 transmits the user's order to the online system 140 and the online system 140 selects a picker to travel to the grocery store source location to collect the groceries ordered by the user. The online system 140 transmits an offer to the picker for the picker to service the order in exchange for consideration and, if the picker accepts the offer, the picker collects the groceries from the grocery store source location. Once the picker has collected the groceries ordered by the user, the picker delivers the groceries to a location transmitted to the picker client device 110 by the online system 140.

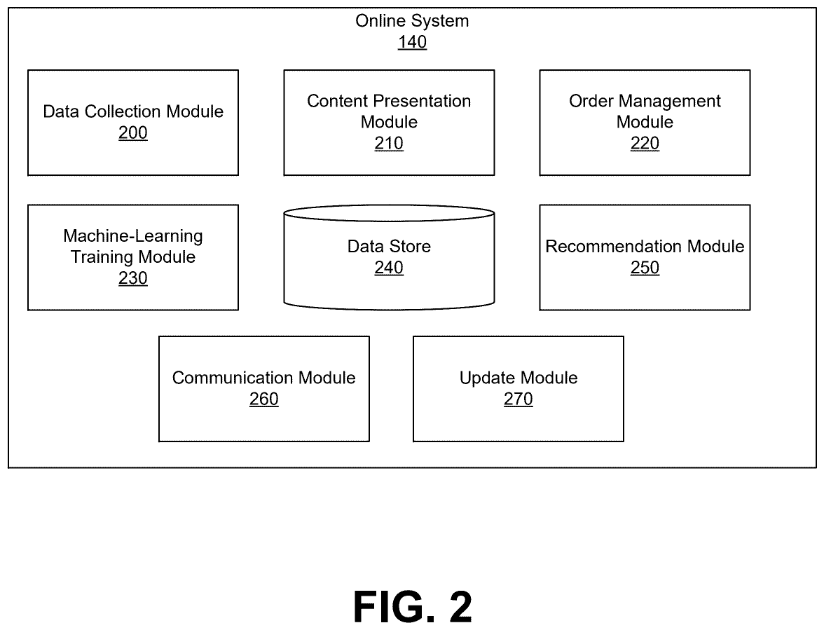

The online system 140 also may maintain one or more white-labeled websites (e.g., storefronts), in which each white-labeled website is designed by a source. The online system 140 may maintain the white-labeled website(s) by hosting the white-labeled website(s), providing the white-labeled website(s) with website administration and security, fulfilling orders placed with the source(s) via the white-labeled website(s), etc. For example, each source may design a white-labeled website by selecting elements, such as text, images, videos, collections of items, menus, banners, icons, interactive elements, etc., included in the white-labeled website, and determining a layout of the white-labeled website (e.g., by arranging the elements, determining an orientation or an alignment of the elements, etc.). In the above example, once users place orders via the white-labeled website, the online system 140 may transmit the orders to picker client devices 110 associated with pickers who may accept the orders, collect the ordered items from source locations, and deliver the ordered items to the users. The online system 140 may track various types of information associated with each white-labeled website it maintains, such as performance metrics associated with each white-labeled website (e.g., a conversion rate, a user retention rate, a session duration, a gross merchandise value (GMV), etc.). The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, a data store 240, a recommendation module 250, a communication module 260, and an update module 270. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

The data collection module 200 collects user data, which is information or data that describe characteristics of a user. User data may include a user's name, address, shopping preferences, favorite items, or stored payment instruments. The user data also may include default settings established by the user, such as a default source/source location, payment instrument, delivery location, or delivery timeframe. User data also may include a geographical location associated with a user, such as a delivery address associated with the user, a geographical location of a user client device 100 associated with the user, etc. The user data also may include information describing interactions by a user with the online system 140. For example, user data may include information describing search queries received from user client devices 100 associated with users of the online system 140. In this example, the user data may include information describing an item associated with each search, a time of each search, and a geographical location associated with a user associated with each search. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for an item. The item data also may include various types of information describing each item, such as a set of images or videos depicting the item, text describing the item, etc. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular source location), the item data may include a time that the item was last found, a time that the item was last not found (a picker looked for the item but could not find it), the rate at which the item is found, or the popularity of the item. The data collection module 200 may collect item data from a source computing system 120, a picker client device 110, or a user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online system 140, a user rating for the picker, the sources from which the picker has collected items, or the picker's previous shopping history. Additionally, the picker data may include preferences expressed by the picker, such as their preferred sources for collecting items, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data describing characteristics of an order. For example, order data may include item data for items that are included in an order, a delivery location for the order, a user associated with the order, a source location from which the user wants the ordered items collected, or a timeframe within which the user wants the order delivered. Order data may further include information describing how an order was serviced, such as which picker serviced the order, when the order was delivered, or a rating that the user gave the delivery of the order. Order data also may include information communicated between a user client device 100 and a picker client device 110 associated with an order, such as messages including questions a picker servicing the order had for a user who placed the order, the user's responses to the picker's questions, images of items captured by the picker client device 110, etc. In some embodiments, the order data include user data for users associated with the order, such as user data for a user who placed the order or picker data for a picker who serviced the order.

Similarly, the data collection module 200 may collect purchase data, which is information or data describing characteristics of a purchase by a user who collected and purchased items for themselves from a source location. The purchase data may include item data for items included in purchases or user data for users associated with purchases. For example, purchase data for a purchase may include item data for items that are included in the purchase, user data for a user who made the purchase, and information describing the purchase (e.g., a source location from which the user purchased the items and a date and time of the purchase).

Furthermore, the data collection module 200 collects contextual data associated with white-labeled websites. A set of contextual data associated with a white-labeled website may include information describing a source that designed the white-labeled website. Examples of such information include: a brand voice of the source, a mission statement of the source, a type of the source, or any other suitable types of information. For example, a set of contextual data associated with a white-labeled website may describe a brand voice of the source, which is a distinct personality, tone, or style with which the source communicates with users (e.g., via emails, banners, text messages, etc.). In this example, the set of contextual data may indicate whether the brand voice is humorous, playful, informal, friendly, etc. In embodiments in which a set of contextual data associated with a white-labeled website includes a brand voice of a source, the brand voice may be explicitly provided by the source (e.g., via a source computing system 120 associated with the source) or derived (e.g., by the data collection module 200, as described below). As an additional example, a set of contextual data associated with a white-labeled website may include a mission statement of a source that designed the white-labeled website (e.g., sustainability, user satisfaction, low prices, wide selection, high quality items, specialty items, etc.) or information describing a type of the source (e.g., discount, high end, warehouse, etc.).

A set of contextual data associated with a white-labeled website also may include information describing one or more elements of the white-labeled website. Examples of such elements include: a layout of the white-labeled website, text, an image, a video, a collection of items, a menu, a banner, or an interactive element included in the white-labeled website, or any other suitable types of elements. For example, a set of contextual data associated with a white-labeled website may describe its layout, such as an arrangement, orientation, or alignment of banners, menus, images, text, etc. included in the white-labeled website, whether the white-labeled website is cluttered, a position of any unused whitespace included in the white-labeled website, etc. In the above example, the set of contextual data also may describe one or more images included in the white-labeled website (e.g., included in descriptions of items, banners, etc.), such as the dimensions or quality (e.g., values describing contrast, blur, noise, artifacts, distortion, etc.) of each image. Continuing with this example, the set of contextual data also may describe text included in the white-labeled website, such as the language, content, or font type, size, or color of text included in descriptions of items, banners, etc. In this example, the set of contextual data also may include a collection of items included in the white-labeled website, such as a collection of trending items, gift ideas for an upcoming holiday, items included in a marketing campaign or a promotion, items a user recently ordered, items a user frequently orders, etc.

A set of contextual data associated with a white-labeled website further may include information describing a historical performance of the white-labeled website. A historical performance of a white-labeled website may be described by one or more metrics. Examples of such metrics include: a conversion rate, a user retention rate, an average session duration, a GMV, or any other suitable types of metrics. For example, a set of contextual data associated with a white-labeled website may include a conversion rate associated with the white-labeled website or an average session duration of users on the white-labeled website during one or more previous timespans (e.g., one or more previous months or quarters). In this example, the set of contextual data associated with the white-labeled website also may include a total number of conversions associated with the white-labeled website during the previous timespan(s), a value associated with each conversion associated with the white-labeled website (e.g., an amount of each order placed with a source that designed the white-labeled website), etc.

A set of contextual data associated with a white-labeled website also may include one or more times associated with the set of contextual data or any other suitable types of information associated with the white-labeled website. For example, a set of contextual data associated with a white-labeled website may include a time associated with a conversion associated with the white-labeled website or a timespan associated with a conversion rate associated with the white-labeled website. In the above example, the set of contextual data also may include a timespan during which the white-labeled website included a particular element (e.g., a particular image, text, layout, or collection of items), a time at which the element was changed, etc. As an additional example, a set of contextual data associated with a white-labeled website may include a timespan associated with a particular user retention rate, average session duration, or GMV.

In some embodiments, the data collection module 200 derives information from other information stored in the data store 240. The data collection module 200 may do so using optical character recognition (OCR), natural language processing (NLP), computer-vision, speech recognition, or any other suitable technique or combination of techniques. For example, if the user data describe search queries received from user client devices 100 associated with users, such as an item and a time associated with each search, based on the user data, the data collection module 200 may derive information describing a set of trending searches received by the online system 140 (e.g., items for which the users searched at least a threshold number of times within the past three days). In the above example, if the user data also include a geographical location (e.g., a city, a county, or a state) associated with each user, the set of trending searches may be specific to a geographical location associated with the users. As an additional example, based on text included in a white-labeled website designed by a source or any other elements included in the white-labeled website, the data collection module 200 may derive information describing the source, such as a brand voice that the source uses to communicate with users, a mission statement of the source, a type of the source, etc.

To illustrate how the data collection module 200 may derive information from other information stored in the data store 240, suppose that contextual data associated with a white-labeled website includes a value and a time associated with each conversion associated with the white-labeled website and a time at which each element of the white-labeled website was changed. In this example, based on the contextual data, the data collection module 200 may derive an average value associated with conversions associated with the white-labeled website during a timespan before one or more elements of the white-labeled website were changed and another average value associated with conversions associated with the white-labeled website during another timespan after the element(s) was/were changed. As an additional example, suppose that order data for an order includes a message communicated from a picker client device 110 to a user client device 100 associated with an order, in which the message includes an image of strawberries captured by the picker client device 110 (e.g., a smart shopping cart). In this example, the data collection module 200 may derive information indicating a quality of the strawberries based on additional content included in the message and in one or more messages subsequently communicated between the user client device 100 and the picker client device 110. In this example, if the message from the picker client device 110 includes a question about the freshness of the strawberries (e.g., “Do these look fresh to you?”), the data collection module 200 may derive information from this message and a subsequent message from the user client device 100 indicating the strawberries are fresh (e.g., if the message states: “Yes. Those are perfect!”).

While user data, picker data, item data, order data, purchase data, and contextual data associated with white-labeled websites are described separately, data collected by the data collection module 200 may fall into more than one of these categories. For example, data describing a picker's performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. In this example, the content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that a user will order an item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from user client devices 100 and offers the orders to pickers for service based on picker data. For example, the order management module 220 offers an order to a picker based on the picker's location and the source location from which the ordered items are to be collected. The order management module 220 may also offer an order to a picker based on how many items are in the order, a vehicle operated by the picker, the delivery location, the picker's preferences for how far to travel to deliver an order, the picker's ratings by users, or how often the picker agrees to service an order.

In some embodiments, the order management module 220 determines when to offer an order to a picker based on a delivery timeframe requested by the user who placed the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions indicating how the picker may travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model is used by the machine-learning model to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, order data, purchase data, or contextual data associated with white-labeled websites. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases in which the training example includes a label, the loss function is also based on the label for the training example. Some example loss functions include the mean square error function, the mean absolute error, the hinge loss function, and the cross entropy loss function. The machine-learning training module 230 updates the set of parameters for the machine-learning model based on the score generated by the loss function. For example, the machine-learning training module 230 may apply gradient descent to update the set of parameters.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

In some embodiments, once the machine-learning training module 230 trains a machine-learning model, it fine-tunes the machine-learning model by adjusting a set of parameters of the machine-learning model to tailor it to perform a more specific task. The machine-learning training module 230 may do so by fine-tuning the pre-trained machine-learning model on a task-specific dataset that is more specific than the set of training examples used to train the model. The machine-learning training module 230 may fine-tune a machine-learning model via instruction fine-tuning, full fine-tuning, parameter-efficient fine-tuning, transfer learning, task-specific fine-tuning, multi-task learning, sequential fine-tuning, or using any other suitable technique or combination of techniques.

The data store 240 stores data used by the online system 140. For example, the data store 240 stores user data, item data, order data, purchase data, picker data, and contextual data associated with white-labeled websites for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

The recommendation module 250 may retrieve various types of data from the data store 240. In some embodiments, the data retrieved by the recommendation module 250 include contextual data associated with one or more white-labeled websites. As described above, a set of contextual data associated with a white-labeled website may include information describing a source that designed the white-labeled website, one or more elements of the white-labeled website, a historical performance of the white-labeled website, one or more times associated with the set of contextual data, etc. For example, the recommendation module 250 may retrieve a set of contextual data associated with each of multiple white-labeled websites designed by multiple sources. In this example, each set of contextual data may describe a set of changes to one or more elements of a white-labeled website, a set of changes to a performance of the white-labeled website, or a timing of the former relative to the latter. In the above example, the set of contextual data may indicate whether the performance improved or deteriorated within a threshold amount of time that the set of changes were made to the element(s). The data retrieved by the recommendation module 250 also may include user data for one or more users of the online system 140, item data for one or more items, or any other suitable types of data. For example, the recommendation module 250 may retrieve user data describing trends associated with users of the online system 140 (e.g., a set of trending searches received from user client devices 100 associated with various users). As an additional example, the recommendation module 250 may retrieve item data for items available at one or more source locations (e.g., images of the items, descriptions of the items, etc.).

The recommendation module 250 also may generate a prompt that includes a request for a set of recommendations for improving a performance of a white-labeled website by updating a set of elements of the white-labeled website. For example, the request included in the prompt may be for a set of recommendations for improving a conversion rate or a user retention rate, or increasing a session duration or a GMV of a white-labeled website by updating a layout of the white-labeled website, or text, one or more images, collections of items, etc. included in the white-labeled website. In some embodiments, the request describes one or more ways in which the set of elements may be updated. In the above example, the request may indicate whether the set of elements may be updated by modifying them or by replacing them with a new set of elements. In various embodiments, the request describes one or more specific elements or issues that the set of recommendations may address. Continuing with the above example, the request may indicate that the layout may be updated to address issues such as clutter, image orientation, positioning, or consistency (e.g., of alignment, font size or color, etc.) or that the image(s) may be updated to address issues such as clarity, blurriness, distortion, stretching, and contrast detected around text. In the above example, the request also may indicate that the text may be updated to address issues related to grammar, spelling, conciseness, and overall impact or that the collection(s) of items may be updated based on trends (e.g., trending searches received via the white-labeled website or the online system 140 that are specific to a geographical location associated with a source that designed the white-labeled website). The prompt may include text data, image data, video data, audio data, or any other suitable types of data. In the above example, the prompt may include text describing each element that may be updated and the issues to be addressed, and an image or a video depicting the elements.

A prompt generated by the recommendation module 250 also may include additional types of information, such as information it retrieves from the data store 240 (e.g., a set of contextual data associated with one or more white-labeled websites, user data, item data, etc.), or any other suitable types of information. For example, the prompt may include contextual data associated with one or more white-labeled websites indicating whether a set of performance metrics (e.g., a conversion rate, a user retention rate, an average session duration, a GMV, etc.) associated with each white-labeled website improved or deteriorated within a threshold amount of time after a set of elements of the corresponding white-labeled website was changed. In this example, the set of elements of each white-labeled website and the changes to the set of elements may be described by one or more images or videos included in the prompt depicting the set of elements prior to and after the changes were made. Alternatively, in this example, the contextual data may include examples of the set of elements of each white-labeled website (e.g., images or videos depicting the set of elements), in which each example is associated with a set of performance metrics (e.g., various conversion rates, user retention rates, GMVs, average session durations, etc.). In some embodiments, the prompt includes information or examples indicating how a set of elements of a white-labeled website may be changed to improve its performance. For example, the prompt may include information describing a set of trending searches received from user client devices 100 associated with various users, which may indicate how a collection of items included in the white-labeled website may be changed to improve its performance. In this example, the prompt also may include item data, such as images, descriptions, etc., of items available at source locations that may be used to generate new images or new text to replace images or text in the white-labeled website.

The recommendation module 250 may provide a prompt it generates to a large language model (LLM), such as a multi-modal LLM, or any other suitable generative artificial intelligence (AI) model to obtain an output. In some embodiments, the LLM is fine-tuned based on information retrieved by the recommendation module 250 (e.g., based on a set of contextual data associated with each of one or more white-labeled websites, item data for various items, etc.). For example, the LLM may be fine-tuned based on information describing a historical performance of a white-labeled website by further training it on a labeled dataset, in which the labels indicate whether a change to an element of the white-labeled website was associated with an improvement or a deterioration in the performance of the white-labeled website. In this example, the LLM also may be fine-tuned based on information describing a set of trending searches received from user client devices 100 associated with various users of the online system 140 during times associated with the labeled dataset. In some embodiments, the LLM is trained or fine-tuned by the machine-learning training module 230. In embodiments in which the LLM is fine-tuned based on information retrieved by the recommendation module 250, the prompt may not include this information. For example, if the LLM is fine-tuned based on a set of contextual data associated with a white-labeled website, the prompt provided to the LLM may not include the set of contextual data.

Once the recommendation module 250 provides a prompt to the LLM (or other generative AI model), it may receive an output from the LLM and extract a set of recommendations for improving a performance of a white-labeled website from the output. For example, if an image included in a white-labeled website is overlaid with text that is less than a threshold font size or of a font color that results in less than a threshold color contrast ratio, the output of the LLM may include a recommendation to increase the font size of the text or to change the font color of the text to increase the color contrast ratio. In embodiments in which the LLM is a multi-modal LLM or any other type of generative AI model capable of generating images, videos, or other types of content, the output may include such types of content. For example, the output may include an image depicting an updated layout of a white-labeled website or an updated image included in the white-labeled website, in which the layout or image has been updated based on the set of recommendations for improving the performance of the white-labeled website. In various embodiments, the set of recommendations for improving the performance of the white-labeled website is communicated via an example that illustrates the set of recommendations. For example, if the set of recommendations for improving the performance of the white-labeled website includes a recommendation to center images included in the white-labeled website, the set of recommendations may be communicated via an example of a layout including images that are centered.

The following discussion illustrates examples of a set of recommendations for improving a performance of a white-labeled website that may be extracted from an output of the LLM (or other generative AI model) based on a prompt provided to the LLM. Suppose that a prompt provided to the LLM includes a request for a recommendation to improve a performance of a white-labeled website by updating a layout of the white-labeled website to address issues such as clutter, image orientation, and positioning. In this example, suppose also that most, but not all content items (e.g., banners, links, items, etc.) included in the white-labeled website are aligned along the left side of the white-labeled website, such that a portion of the layout to the left of a content item includes unused empty space. In the above example, the output of the LLM may include an image pointing out the unused empty space and a recommendation to align the content item along the left side of the white-labeled website with an image depicting the recommended layout. As an additional example, suppose that a prompt provided to the LLM includes a request for a recommendation to improve a performance of a white-labeled website by updating one or more images included in the white-labeled website to clarify attributes (e.g., sizes, colors, weights, etc.) of items depicted in the image(s). In this example, if dimensions of an item described as “Haas Avocado (Large)” are not included in a description of the item or an image of the item, the output of the LLM may include a recommendation to replace the image with another image included in the output that depicts the size of a large Haas avocado relative to other sizes of Haas avocados.

The following discussion illustrates additional examples of a set of recommendations for improving a performance of a white-labeled website that may be extracted from an output of the LLM (or other generative AI model) based on a prompt provided to the LLM. Suppose that a prompt provided to the LLM includes a request for a recommendation to improve a performance of a white-labeled website by updating text included in the white-labeled website to make it more consistent with a brand voice of a source that designed the white-labeled website. In this example, if text describing an item included in the white-labeled website is formal, but the brand voice of the source is informal and playful, the output of the LLM may include a recommendation to replace the text with different text included in the output that is more informal and playful. Alternatively, in the above example, suppose that the request is for a recommendation to improve the performance of the white-labeled website by updating the text included in the white-labeled website to address issues related to grammar, spelling, conciseness, and overall impact. In this example, if the text included in the white-labeled website is wordy and confusing, the output of the LLM may include a recommendation to replace the text with different text included in the output that is clearer and more concise. As an additional example, suppose that a prompt provided to the LLM includes a request for a recommendation to improve a performance of a white-labeled website by updating a collection of items included in the white-labeled website. In this example, if the Super Bowl is approaching and trending searches received by the online system 140 include searches for chips and chicken wings, the output of the LLM may include a recommendation to replace the collection of items with another collection of items described in the output including chips and chicken wings.

The communication module 260 may send a set of recommendations for improving a performance of a white-labeled website to a source computing system 120 associated with a source that designed the white-labeled website. The source may then update a set of elements of the white-labeled website based on the set of recommendations. For example, suppose that a set of recommendations for improving a performance of a white-labeled website includes a recommendation to update a layout of the white-labeled website by aligning all of its content along the left side of the white-labeled website, as depicted in an image included in the recommendation. In this example, suppose also that the set of recommendations includes a recommendation to replace a blurry image included in the white-labeled website with a clearer one depicted in an image included in the recommendation. In the above example, the recommendation module 250 may send the set of recommendations to a source computing system 120 associated with a source that designed the white-labeled website (e.g., via an email, a push notification, etc.) and the source may then update the white-labeled website. Alternatively, the set of recommendations may be sent to the source computing system 120 with a set of options that allow the source to accept some or all of the recommendations. In the above example, suppose that each recommendation sent to the source computing system 120 is associated with an interactive element (e.g., a button) that allows the source to accept a corresponding recommendation, and that the communication module 260 receives information describing one or more recommendations accepted by the source. In this example, the communication module 260 may send information describing the accepted recommendation(s) to the update module 270 (described below), which may then update the set of elements included in the white-labeled website accordingly.

In some embodiments, the update module 270 updates a set of elements of a white-labeled website based on a set of recommendations extracted from an output of the LLM (or other generative AI model). The update module 270 may do so automatically responsive to the extraction of the set of recommendations by the recommendation module 250. For example, if a set of recommendations for improving a performance of a white-labeled website includes a recommendation to replace text included in the white-labeled website with different text that is more consistent with a brand voice of a source that designed the white-labeled website, the update module 270 may update the text by replacing it with the text that is more consistent with the brand voice. In embodiments in which the set of recommendations is sent to a source computing system 120 associated with a source that designed the white-labeled website along with a set of options that allow the source to accept some or all of the recommendations, responsive to receiving information describing one or more recommendations accepted by the source, the update module 270 may update the set of elements included in the white-labeled website accordingly.

### Prompting a Large Language Model to Provide Recommendations for Improving a Performance of a White-Labeled Website

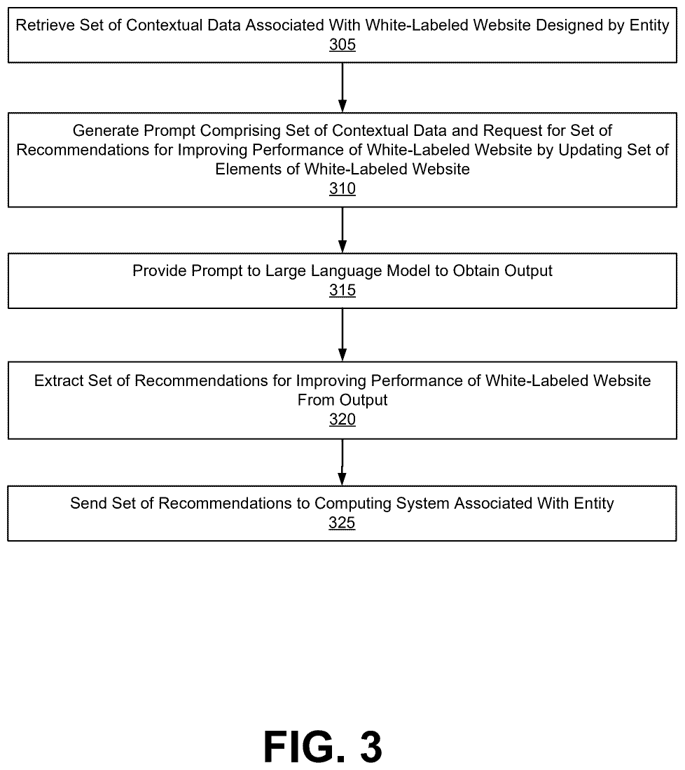

FIG. 3 is a flowchart of a method for prompting a large language model to provide recommendations for improving a performance of a white-labeled website, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system without human intervention.

The online system 140 maintains one or more white-labeled websites, in which each white-labeled website is designed by a source. The online system 140 may maintain the white-labeled website(s) by hosting the white-labeled website(s), providing the white-labeled website(s) with website administration and security, fulfilling orders placed with the source(s) via the white-labeled website(s), etc. The online system 140 may track various types of information associated with each white-labeled website it maintains, such as performance metrics associated with each white-labeled website (e.g., a conversion rate, a user retention rate, a session duration, a GMV, etc.).

The online system 140 retrieves 305 (e.g., using the recommendation module 250) a set of contextual data associated with a white-labeled website designed by a source (e.g., from the data store 240). The set of contextual data may include information describing the source that designed the white-labeled website. Examples of such information include: a brand voice of the source, a mission statement of the source, a type of the source, or any other suitable types of information. In embodiments in which the set of contextual data includes a brand voice of the source, the brand voice may be explicitly provided by the source (e.g., via a source computing system 120 associated with the source) or derived by the online system 140 (e.g., using the data collection module 200). The set of contextual data also may include information describing one or more elements of the white-labeled website. Examples of such elements include: a layout of the white-labeled website, text, an image, a video, a collection of items, a menu, a banner, an icon, or an interactive element included in the white-labeled website, or any other suitable types of elements. The set of contextual data further may include information describing a historical performance of the white-labeled website. The historical performance of the white-labeled website may be described by one or more metrics. Examples of such metrics include: a conversion rate, a user retention rate, an average session duration, a GMV, or any other suitable types of metrics. Furthermore, the set of contextual data may include one or more times associated with the set of contextual data or any other suitable types of information. The online system 140 also may retrieve (step 305) additional types of data (e.g., from the data store 240). Examples of such types of data include: contextual data associated with one or more additional white-labeled websites, user data for one or more users of the online system 140 (e.g., trends associated with the user(s)), item data for one or more items available at one or more source locations, or any other suitable types of data.

The online system 140 then generates 310 (e.g., using the recommendation module 250) a prompt that includes a request for a set of recommendations for improving a performance of the white-labeled website by updating the set of elements of the white-labeled website. In some embodiments, the request describes one or more ways in which the set of elements may be updated (e.g., by modifying the set of elements or by generating a new set of elements to replace the set of elements). In various embodiments, the request describes one or more specific elements or issues that the set of recommendations may address (e.g., updating the layout to address issues such as clutter, image orientation, positioning, or consistency). The prompt may include text data, image data, video data, audio data, or any other suitable types of data. The prompt also may include additional types of information, such as information it retrieves 305 (e.g., from the data store 240), such as the set of contextual data associated with the white-labeled website or contextual data associated with one or more additional white-labeled websites, user data, item data, etc., or any other suitable types of information. In some embodiments, the prompt includes information or examples indicating how the set of elements of the white-labeled website may be changed to improve its performance, such as information describing a set of trending searches or examples of images, descriptions, etc. of items available at various source locations.

The online system 140 provides 315 (e.g., using the recommendation module 250) the prompt to an LLM, such as a multi-modal LLM, or any other suitable generative AI model to obtain an output. In various embodiments, the LLM is fine-tuned based on information retrieved 305 by the online system 140 (e.g., based on a set of contextual data associated with each of one or more white-labeled websites, item data for various items, etc.). In some embodiments, the LLM is trained or fine-tuned by the online system 140 (e.g., using the machine-learning training module 230). In embodiments in which the LLM is fine-tuned based on information retrieved 305 by the online system 140, the prompt may not include this information.

Once the online system 140 provides 315 the prompt to the LLM (or other generative AI model), it may receive an output from the LLM and extract 320 (e.g., using the recommendation module 250) the set of recommendations for improving the performance of the white-labeled website from the output. In embodiments in which the LLM is a multi-modal LLM or any other type of generative AI model capable of generating images, videos, or other types of content, the output may include such types of content. In various embodiments, the set of recommendations for improving the performance of the white-labeled website is communicated via an example that illustrates the set of recommendations.

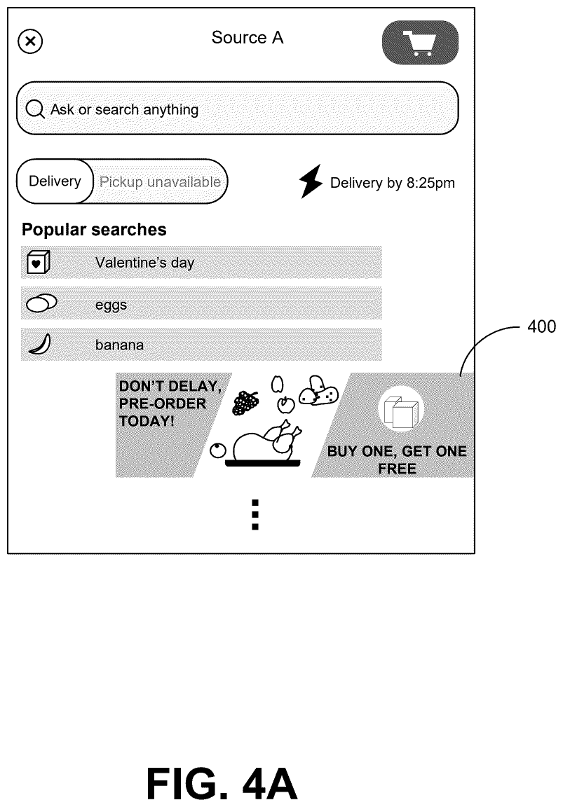

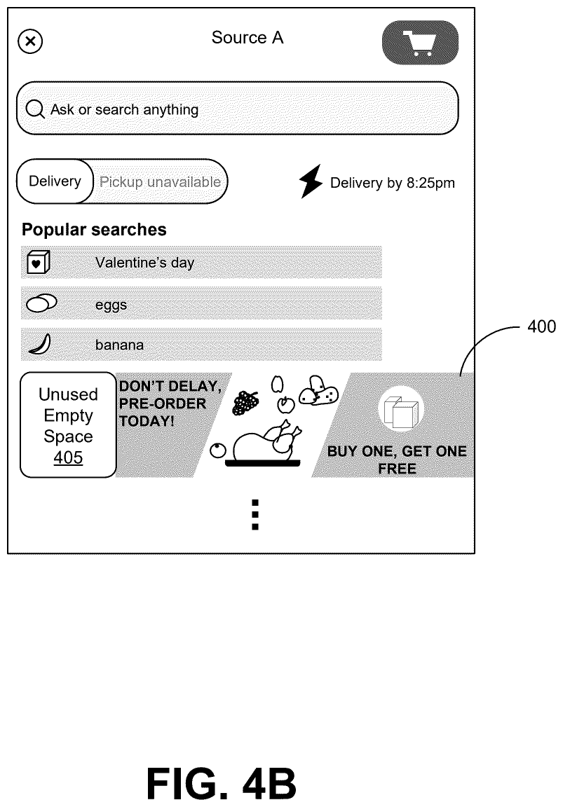

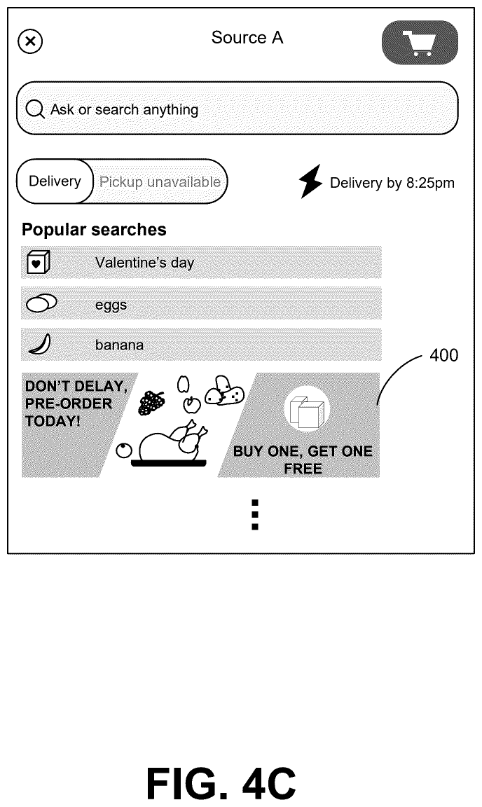

FIGS. 4A-4C illustrate an example of a recommendation for updating a layout of a white-labeled website, in accordance with one or more embodiments. Suppose that the prompt provided 315 to the LLM includes a request for a recommendation to improve the performance of the white-labeled website by updating a layout of the white-labeled website to address issues such as clutter, image orientation, and positioning. In this example, suppose also that most, but not all content items (e.g., banners, links, items, etc.) included in the white-labeled website are aligned along the left side of the white-labeled website, such that a portion of the layout to the left of a content item 400 includes unused empty space, as shown in FIG. 4A. In the above example, the output of the LLM may include an image pointing out the unused empty space 405, as shown in FIG. 4B, and a recommendation to align the content item 400 along the left side of the white-labeled website with an image depicting the recommended layout, as shown in FIG. 4C.

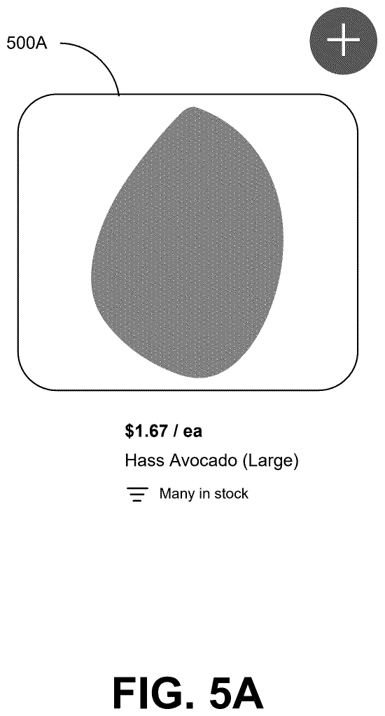

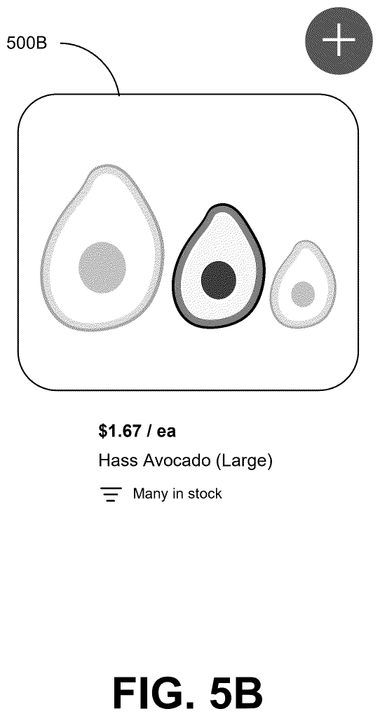

FIGS. 5A-5B illustrate an example of a recommendation for updating an image included in a white-labeled website, in accordance with one or more embodiments. Suppose that the prompt provided 315 to the LLM includes a request for a recommendation to improve the performance of the white-labeled website by updating one or more images included in the white-labeled website to clarify attributes (e.g., sizes, colors, weights, etc.) of items depicted in the image(s). In this example, if dimensions of an item described as “Haas Avocado (Large)” are not included in a description of the item or an image 500A of the item, as shown in FIG. 5A, the output of the LLM may include a recommendation to replace the image 500A with another image 500B included in the output that depicts the size of a large Haas avocado relative to other sizes of Haas avocados, as shown in FIG. 5B.

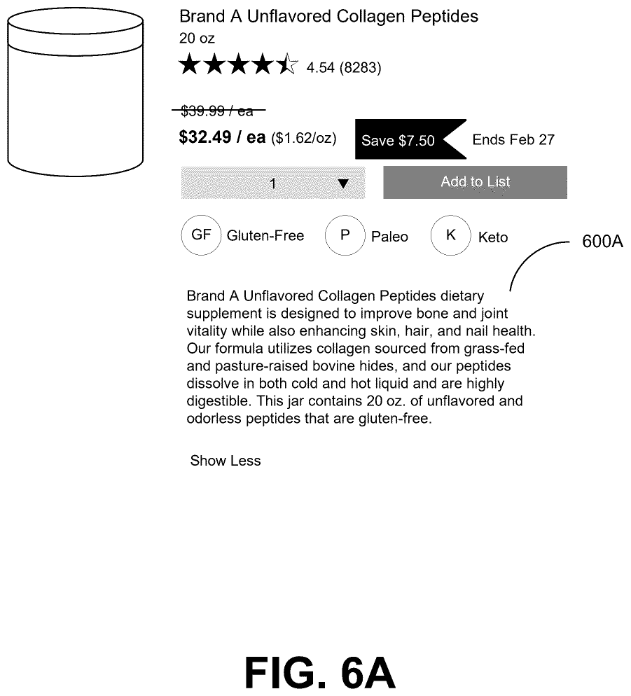

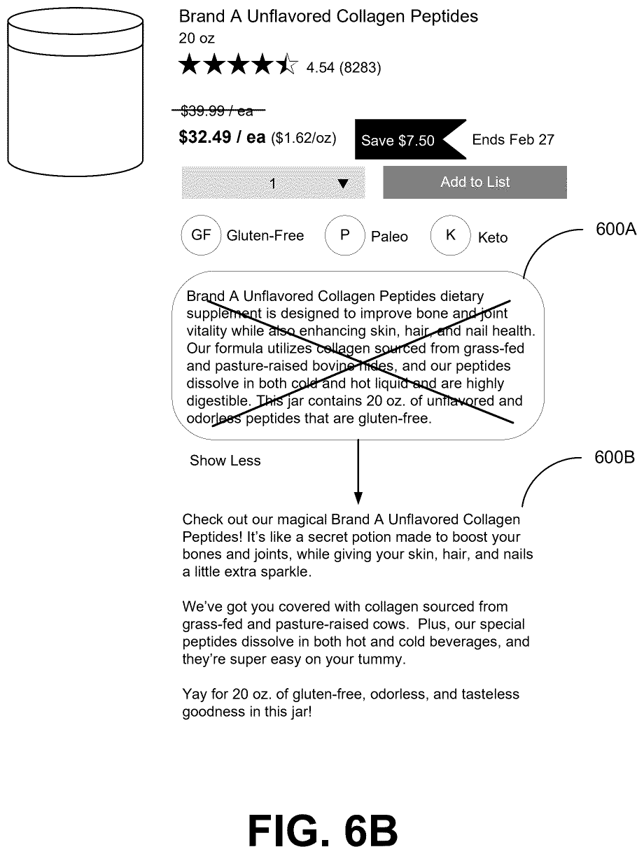

FIGS. 6A-6B illustrate an example of a recommendation for updating text included in a white-labeled website, in accordance with one or more embodiments. Suppose that the prompt provided 315 to the LLM includes a request for a recommendation to improve the performance of the white-labeled website by updating text included in the white-labeled website to make it more consistent with the brand voice of the source that designed the white-labeled website. In this example, if text 600A describing an item included in the white-labeled website is formal, as shown in FIG. 6A, but the brand voice of the source is informal and playful, the output of the LLM may include a recommendation to replace the text 600A with different text 600B included in the output that is more informal and playful, as shown in FIG. 6B.

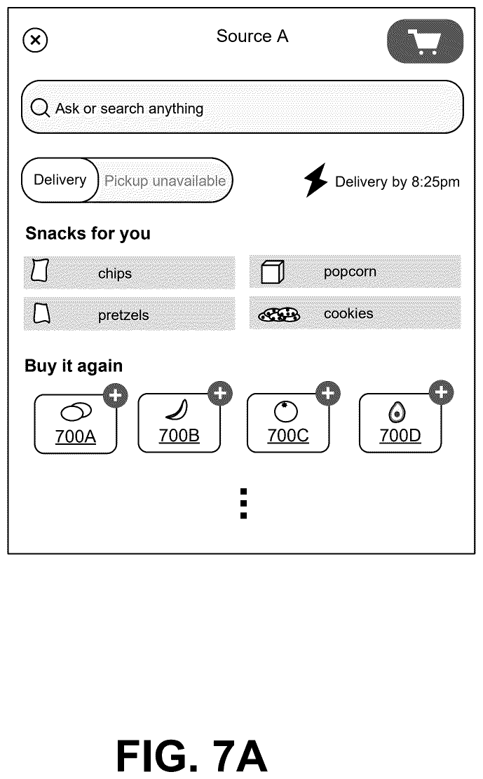

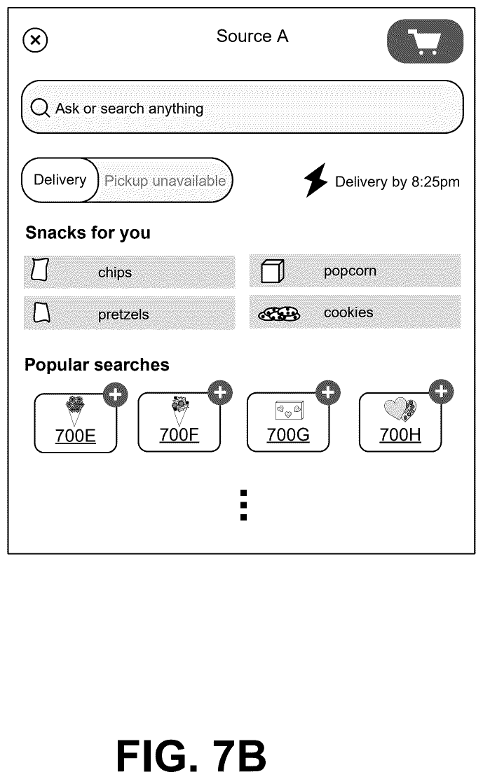

FIGS. 7A-7B illustrate an example of a recommendation for updating a collection of items included in a white-labeled website, in accordance with one or more embodiments. Suppose that the prompt provided 315 to the LLM includes a request for a recommendation to improve the performance of the white-labeled website by updating a collection of items 700A-D included in the white-labeled website, as shown in FIG. 7A. In this example, if Valentine's Day is approaching and trending searches received by the online system 140 include searches for bouquets of flowers and chocolate, the output of the LLM may include a recommendation to replace the collection of items 700A-D with another collection of items 700E-H described in the output including bouquets of flowers and chocolate, as shown in FIG. 7B.

Referring back to FIG. 3, once the online system 140 extracts 320 the set of recommendations, the online system 140 may send 325 (e.g., using the communication module 260) the set of recommendations to a source computing system 120 associated with the source that designed the white-labeled website. The source may then update the set of elements of the white-labeled website based on the set of recommendations. Alternatively, the set of recommendations may be sent 325 to the source computing system 120 with a set of options that allow the source to accept some or all of the recommendations.

In some embodiments, the online system 140 updates (e.g., using the update module 270) the set of elements of the white-labeled website based on the extracted set of recommendations. The online system 140 may do so automatically responsive to the extraction of the set of recommendations. In embodiments in which the set of recommendations is sent 325 to the source computing system 120 associated with the source that designed the white-labeled website along with a set of options that allow the source to accept some or all of the recommendations, responsive to receiving information describing one or more recommendations accepted by the source, the online system 140 may update the set of elements included in the white-labeled website accordingly.

In one or more embodiments, the online system 140 collects feedback about the recommendations or the updated elements of the white-labeled website. This feedback may be collected explicitly, such as by asking questions to a user, or implicitly, such as by logging user confirmations of the recommendations. The collected feedback may then be used to retrain the machine-learning models used to make the recommendations.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, comprising:
retrieving, at an online system that maintains a website designed by an entity, a set of contextual data associated with the website, the set of contextual data comprising information describing one or more of: the entity, one or more elements of the website, or a historical performance of the website;
generating a prompt comprising:
a request for a set of recommendations for improving a performance of the website by updating a set of elements of the website, and
the set of contextual data associated with the website;
providing the prompt to a large language model to obtain an output;
extracting, from the output of the large language model, the set of recommendations for improving the performance of the website; and
sending, to a computing system associated with the entity, the set of recommendations for improving the performance of the website.

2. The method of claim 1, wherein generating the prompt comprises including, in the prompt, a first set of examples of the one or more elements of the website associated with an improvement in the performance of the website and a second set of examples of the one or more elements of the website associated with a deterioration in the performance of the website.

3. The method of claim 1, further comprising:
responsive to extracting, from the output of the large language model, the set of recommendations for improving the performance of the website, automatically updating the website based at least in part on the set of recommendations.

4. The method of claim 1, wherein retrieving the one or more elements of the website comprises retrieving one or more of: a layout of the website, an image included on the website, text included on the website, or a collection of one or more items included on the website.

5. The method of claim 1, further comprising:
fine-tuning the large language model based at least in part on the set of contextual data associated with the website.

6. The method of claim 1, wherein retrieving the set of contextual data associated with the website comprises retrieving information describing a first set of changes to one or more elements of the website, information describing a second set of changes to the performance of the website, and information describing a timing of the first set of changes relative to the second set of changes.

7. The method of claim 1, further comprising:
deriving the information describing the entity based at least in part on the one or more elements of the website; and
storing the information describing the entity.

8. The method of claim 1, wherein providing the prompt to the large language model to obtain the output comprises providing the prompt to a multi-modal large language model to obtain the output.

9. The method of claim 8, wherein extracting, from the output of the large language model, the set of recommendations for improving the performance of the website comprises extracting, from the output of the multi-modal large language model, one or more of: an updated layout of the website or an updated image included on the website.

10. The method of claim 1, further comprising:
retrieving additional information describing one or more of: item data for a plurality of items available at one or more source locations operated by one or more entities or a set of trending searches received by the online system; and
including the additional information in the prompt.

11. A computer program product comprising a non-transitory computer-readable storage medium having instructions encoded thereon that, when executed by a processor, cause the processor to perform steps comprising:
retrieving, at an online system that maintains a website designed by an entity, a set of contextual data associated with the website, the set of contextual data comprising information describing one or more of: the entity, one or more elements of the website, or a historical performance of the website;
generating a prompt comprising:
a request for a set of recommendations for improving a performance of the website by updating a set of elements of the website, and
the set of contextual data associated with the website;
providing the prompt to a large language model to obtain an output;
extracting, from the output of the large language model, the set of recommendations for improving the performance of the website; and
sending, to a computing system associated with the entity, the set of recommendations for improving the performance of the website.

12. The computer program product of claim 11, wherein generating the prompt comprises including, in the prompt, a first set of examples of the one or more elements of the website associated with an improvement in the performance of the website and a second set of examples of the one or more elements of the website associated with a deterioration in the performance of the website.

13. The computer program product of claim 11, wherein the computer-readable storage medium further has instructions encoded thereon that, when executed by the processor, cause the processor to perform steps comprising:
responsive to extracting, from the output of the large language model, the set of recommendations for improving the performance of the website, automatically updating the website based at least in part on the set of recommendations.

14. The computer program product of claim 11, wherein retrieving the one or more elements of the website comprises retrieving one or more of: a layout of the website, an image included on the website, text included on the website, or a collection of one or more items included on the website.

15. The computer program product of claim 11, wherein the computer-readable storage medium further has instructions encoded thereon that, when executed by the processor, cause the processor to perform steps comprising:
fine-tuning the large language model based at least in part on the set of contextual data associated with the website.

16. The computer program product of claim 11, wherein retrieving the set of contextual data associated with the website comprises retrieving information describing a first set of changes to one or more elements of the website, information describing a second set of changes to the performance of the website, and information describing a timing of the first set of changes relative to the second set of changes.

17. The computer program product of claim 11, wherein the computer-readable storage medium further has instructions encoded thereon that, when executed by the processor, cause the processor to perform steps comprising:
deriving the information describing the entity based at least in part on the one or more elements of the website; and
storing the information describing the entity.

18. The computer program product of claim 11, wherein providing the prompt to the large language model to obtain the output comprises providing the prompt to a multi-modal large language model to obtain the output.

19. The computer program product of claim 18, wherein extracting, from the output of the large language model, the set of recommendations for improving the performance of the website comprises extracting, from the output of the multi-modal large language model, one or more of: an updated layout of the website or an updated image included on the website.

20. A computer system comprising:
a processor; and
a non-transitory computer-readable storage medium storing instructions that, when executed by the processor, perform actions comprising:
retrieving, at an online system that maintains a website designed by an entity, a set of contextual data associated with the website, the set of contextual data comprising information describing one or more of: the entity, one or more elements of the website, or a historical performance of the website;
generating a prompt comprising:
a request for a set of recommendations for improving a performance of the website by updating a set of elements of the website, and
the set of contextual data associated with the website;
providing the prompt to a large language model to obtain an output;
extracting, from the output of the large language model, the set of recommendations for improving the performance of the website; and
sending, to a computing system associated with the entity, the set of recommendations for improving the performance of the website.
